(19) United States
(12) Patent Application Publication
(10) Pub. No.: US 2013/0124956 A1
(43) Pub. Date: May 16, 2013

(54) Coauthoring in a Drawing Tool

(71) Applicants: L. Tucker Hatfield, Kirkland, WA (US); Andrew G. Carlson, Redmond, WA (US); Lennart Yeuk Yee Wong, Bellevue, WA (US); Michael J. Smith, Bellevue, WA (US); Brian T. Hill, Duvall, WA (US); Robert James Straavaldson, Port Orchard, WA (US)

(72) Inventors: L. Tucker Hatfield, Kirkland, WA (US); Andrew G. Carlson, Redmond, WA (US); Lennart Yeuk Yee Wong, Bellevue, WA (US); Michael J. Smith, Bellevue, WA (US); Brian T. Hill, Duvall, WA (US); Robert James Straavaldson, Port Orchard, WA (US)

(73) Assignee: MICROSOFT CORPORATION, Redmond, WA (US)

(21) Appl. No.: 13/294,943

(22) Filed: Nov. 11, 2011

(51) Int. Cl. G06F 17/24

(52) U.S. Cl. 715/211

(57) ABSTRACT

Methods and systems for coauthoring in a drawing tool are described. One computer-implemented method includes displaying a first user name of a first user in association with a first shape on a drawing, and receiving an indication that a second user is collaborating on the drawing. The method includes receiving an indication that the second user has modified a second shape on the drawing. The method also includes, in response to the indication that the second user has modified the second shape, displaying a second user name of the second user in association with the second shape on the drawing. The methods and systems can also include, in some cases, periodic sharing of metadata among coauthors, to indicate edits made by other coauthors.

### RELATED APPLICATIONS

This application is related to co-pending U.S. patent application Ser. No. ______, Attorney Docket No. 14917.1900USU1/333710.01, titled “Collaborative Commenting in a Drawing Tool,” filed on Nov. 11, 2011, which is hereby incorporated by reference in its entirety.

### BACKGROUND

In a collaborative environment, typically, where multiple users can access a common set of files on a server, multiple users often wish to edit the same document, at the same time if possible. In such circumstances, many problems can occur, due to the potential conflicts that might arise among the edits of the users. For example, if a first user and a second user concurrently edit a word or move a drawing object, it is difficult to determine which user's change should be applied to the document. As such, in many circumstances “edit” access to a document is limited to a single user at a time, to avoid the possibility for such editing conflicts. From a user's perspective, this is inconvenient, since only a single user can edit the document at once, and all other users are either locked out of the document entirely or given only “read only” access to the document by the server or application software hosting the document.

To overcome the inefficiencies resulting from limiting edit access to a document, some software systems allow two users to have edit access to the same file, but due to the high probability of conflicting edits occurring still provide some level of edit locking. For example, in some cases documents can be segmented to allow a user to edit (and lock other users to prevent them from editing) one particular segment of the document, while a different user would be allowed to edit (and lock other users to prevent them from editing) a different segment of that document. This example of a segment-locking scheme can be seen in Microsoft Word authoring software, from Microsoft Corporation of Redmond, Wash., in which segments can be defined on a paragraph-by-paragraph basis. In that software application, edits are not published to other users as they occur, and involve locking at least that segment (e.g., the slide or paragraph) of the document to prevent other users from concurrently editing that same segment, causing conflicts.

In some cases, solutions have been attempted where any user can edit any portion of a document, and any conflicts are resolved on a host server, based on a “last edit wins” basis. However, particularly in cases where connectivity to the server or specific timestamps are unreliable, it can be difficult to determine exactly when each edit is applied to a document, to resolve which edit to a same object within the document is to be applied (e.g., in an arrangement in which the most recent change takes precedence over earlier changes). Furthermore, even in these circumstances, it may be difficult for those users to avoid conflicts, even if they were careful to avoid editing over the top of one another. This is because it is difficult for one user's software to notify other remote users of the changes that the editing user is applying with sufficient notice that those other users can opt to not edit the same portion of the document.

In the case of a drawing tool, such as the VISIO® design and drawing tool from Microsoft Corporation of Redmond, Wash., these conflict issues remain in place. However, because each drawing element within that software has a relatively large number of independent properties, it may be the case that two users might wish to edit different and unrelated properties of the same drawing object; in this case, no conflict would occur. This only exacerbates the inefficiencies discussed above, because there are a greater number of opportunities for concurrent collaborative editing, or “coauthoring” that are prevented to avoid the possibility of conflicts.

### SUMMARY

In accordance with the following disclosure, the above and other problems are addressed by the following:

In one aspect, a computer-implemented method includes displaying a first user name of a first user in association with a first shape on a drawing, and receiving an indication that a second user is collaborating on the drawing. The method includes receiving an indication that the second user has modified a second shape on the drawing, and, in response to the indication that the second user has modified the second shape, displaying a second user name of the second user in association with the second shape on the drawing.

In a second aspect, a method executable on a server computing system includes receiving a first request to access a drawing at a server from a first client user, and receiving a second request to access the drawing at the server from a second client user. The method also includes registering the first and second client users as concurrently editing the drawing. The method further includes receiving an indication from the first client user of an edit applied to an object in the drawing by the first client user, and transmitting the indication to the second client user for display at the second client user, the indication defining the object to which the edit was applied without defining the edit that was applied to the object.

In a third aspect, a computing system capable of providing a collaborative drawing environment includes a drawing tool executable on the computing system and configured to allow modifications to a drawing by a first user. The drawing includes a working copy, a base copy, and a download copy. The drawing tool is configured to display a first user name of a first user in association with a first shape on a drawing, and receive an indication that a second user is collaborating on the drawing. The drawing tool is also configured to receive an indication that the second user has modified a second shape on the drawing without receiving the modification of the second shape, and in response to the indication that the second user has modified the second shape, display a second user name of the second user in association with the second shape on the drawing. The drawing tool is configured to periodically update the download copy of the drawing based on modifications received from a server, the modifications including modifications made by the second user.

This Summary is provided to introduce a selection of concepts, in a simplified form, that are further described below in the Detailed Description. This Summary is not intended to identify key or essential features of the claimed subject matter, nor is it intended to be used in any way to limit the scope of the claimed subject matter.

### BRIEF DESCRIPTION OF THE DRAWINGS

FIG. 1 illustrates an example networked arrangement in which coauthoring in a drawing tool could take place.

FIG. 2 illustrates an example system for managing coauthoring in a drawing tool, according to an example embodiment.

FIG. 3 is a flowchart illustrating a process for resolving conflicts in a coauthored drawing upon receiving a user request to save changes to the drawing, according to an example embodiment.

FIG. 4 illustrates an example of concurrent modifications to a drawing performed by two different users.

FIG. 5 illustrates a second example of concurrent modifications to a drawing performed by two different users in which a conflict between modifications may occur.

FIG. 6 is a flowchart illustrating a process for notifying a coauthoring user of modifications to a drawing applied by a coauthoring user, according to an example embodiment.

FIG. 7 is a flowchart illustrating a process for managing notifications of users regarding modifications to a drawing applied by coauthors, according to an example embodiment.

FIG. 8 is a schematic diagram illustrating updates applied to drawing files and related metadata at first and second client computing systems and a server computing system, according to an example embodiment.

FIG. 9 is an example user interface illustrating notifications presented to a user of a drawing tool supporting coauthoring, according to an example embodiment.

FIG. 10 illustrates an example drawing object and notification feature presented to a coauthoring user of a drawing tool, according to an example embodiment.

FIG. 11 illustrates a rotated version of the example drawing object and notification feature illustrated in FIG. 10;

FIG. 12 illustrates an irregularly shaped drawing object and related notification feature presented to a coauthoring user of a drawing tool, according to an example embodiment.

FIGS. 13-15 illustrate a notification feature associated with a connector between two drawing objects, according to example embodiments.

FIG. 16 illustrates example positioning of the notification feature of FIGS. 13-15 relative to a connector in various orientations.

FIG. 17 illustrates example hierarchical layering of notification features relative to adjacent drawing objects, according to an example embodiment.

FIG. 18 illustrates a notification feature associated with a group of drawing objects defined by the drawing tool, according to an example embodiment.

FIGS. 19-20 illustrate example positioning of a notification feature with a user-defined group of drawing objects, according to example embodiments.

FIGS. 21-22 illustrate a detailed notification feature associated with a drawing object illustrating users that have modified the object, according to example embodiments.

FIG. 23 illustrates a portion of a user interface including a list of coauthoring users in a drawing tool, according to a possible embodiment.

FIG. 24 illustrates a portion of a user interface in a drawing tool providing contact information for a coauthor included in the list illustrated in FIG. 23.

FIG. 25 illustrates a notification occurring in a drawing tool, notifying a first user of a coauthoring user accessing a drawing, according to an example embodiment.

FIG. 26 illustrates a notification occurring in a drawing tool, notifying a first user of a coauthoring user ending access to a drawing, according to an example embodiment.

FIG. 27 illustrates a notification available in a user interface of a drawing tool indicating that changes committed to a drawing by coauthors are available for integration into a local copy of the drawing.

FIG. 28 illustrates a progress bar presented in a user interface of a drawing tool indicating that local changes are being resolved in the drawing, according to a possible embodiment.

FIG. 29 illustrates a progress bar presented in a user interface of a drawing tool indicating that changes committed in the local copy of a drawing are being communicated to a server, according to an example embodiment.

FIG. 30 illustrates a notification window presented to a user of a drawing tool upon synchronization at a client computing system of modifications to the drawing made by coauthors, according to an example embodiment.

FIG. 31 is a simplified block diagram of a computing device with which embodiments of the present invention may be practiced.

FIGS. 32A and 32B are simplified block diagrams of a mobile computing device with which embodiments of the present invention may be practiced.

FIG. 33 is a simplified block diagram of a distributed computing system in which embodiments of the present invention may be practiced.

### DETAILED DESCRIPTION

Various embodiments of the present disclosure will be described in detail with reference to the drawings, wherein like reference numerals represent like parts and assemblies throughout the several views. Reference to various embodiments does not limit the scope of the disclosure, which is limited only by the scope of the claims attached hereto. Additionally, any examples set forth in this specification are not intended to be limiting and merely set forth some of the many possible embodiments.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

Embodiments of the present invention are directed to methods, systems, and user interfaces configured to provide concurrent coauthoring of a drawing in a drawing tool. Generally speaking, coauthoring will allow users of a drawing tool to work concurrently in the same drawing, using a combination of server-hosted files and client synchronization processes. Through use of the features described herein, coauthoring users in a drawing tool will be notified of specific features being edited by other coauthors, such that each user can elect to avoid (or not avoid) editing a same drawing object within a drawing, providing greater flexibility and collaborative functionality than is provided in previous systems, which are locked to a single user at a time on a whole-document or segmented basis. The methods and systems described herein provide information to the coauthors of a drawing relating to possible conflicts, but generally do not prevent coauthoring users from overwriting each other's modifications to a drawing. Edits made by coauthors can be merged, such that any such conflicts can be resolved.

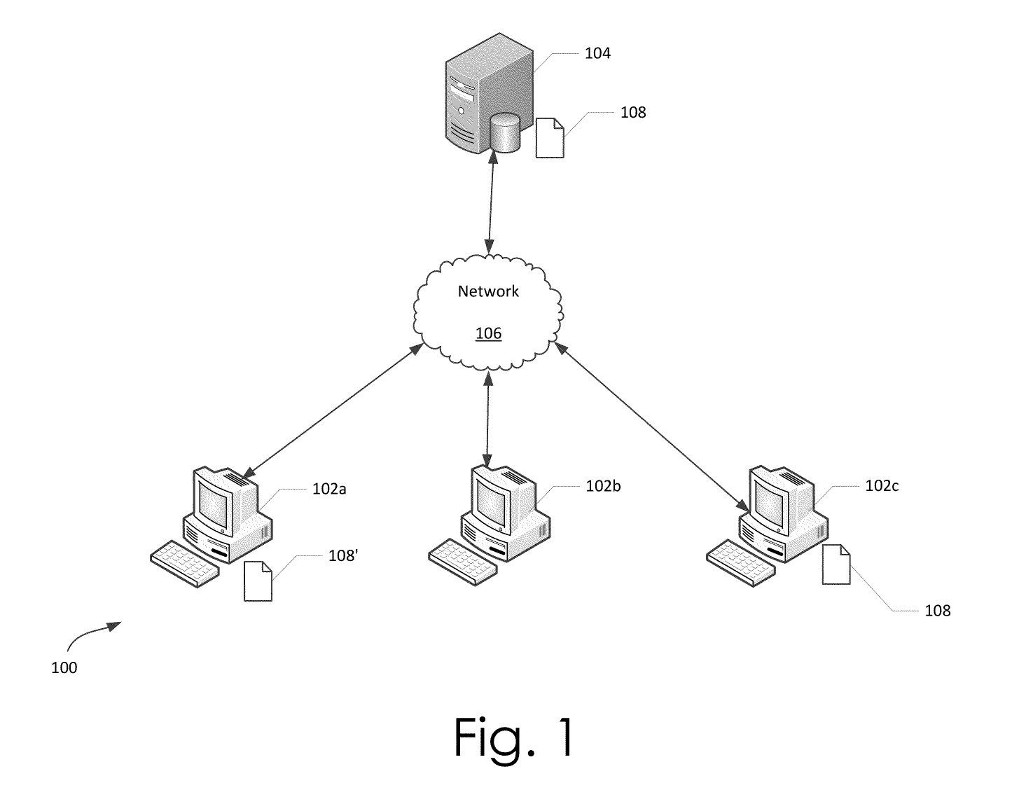

Referring now to FIG. 1, an example of a networked arrangement 100 is illustrated in which coauthoring in a drawing tool could take place. In the embodiment shown, the networked arrangement 100 includes a plurality of client devices 102a-c (referred to collectively or individually as client devices 102), communicatively connected to a server device 104 by way of a network 106, such as the Internet. The client devices 102 generally each include a drawing tool, such as VISIO® drawing and layout software provided by Microsoft Corporation of Redmond, Wash. The server 104 can be any of a number of types of computing systems, and in certain embodiments includes collaborative software, such as SHAREPOINT® server software, also available from Microsoft Corporation.

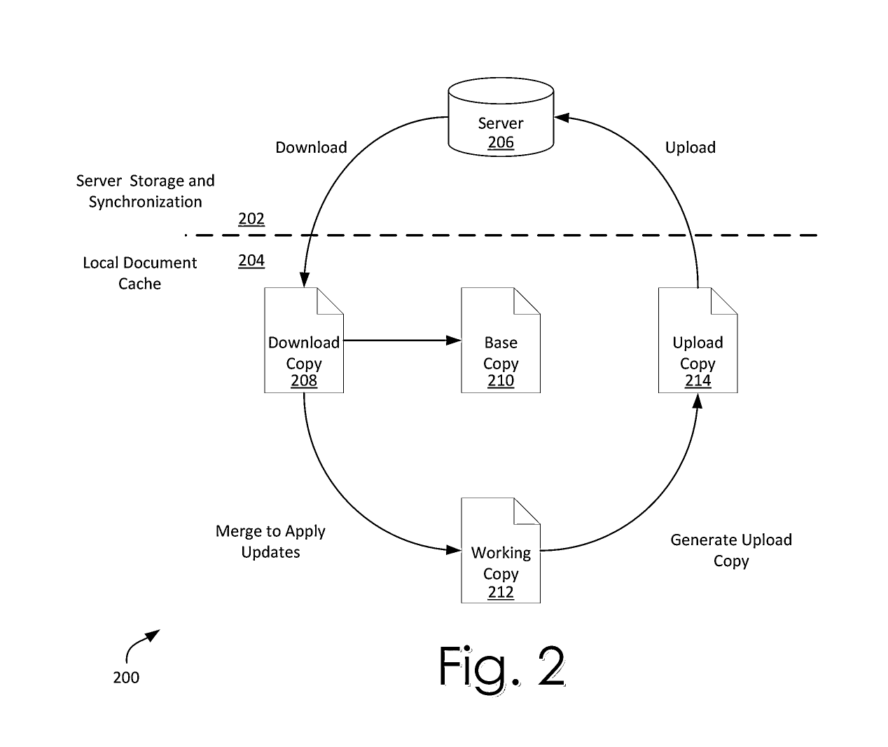

In general the present disclosure is related to a situation in which users of two different client devices 102 intend to access a particular drawing document stored on the server 104. In the embodiment shown, client devices 102a and 102c have accessed a document 108, and stored it as local documents 108′, 108″ on those devices, respectively. As users of those respective client devices 102a, 102c edit the document retrieved from the server 104, the drawing document 108′, 108″ diverge. However, as discussed below in connection with FIGS. 2-8, by synchronizing data across the two devices 102a, 102c (as well as other devices associated with coauthoring users) via the server 104, and by notifying the coauthoring users of edits made by other users, concurrent editing by coauthors can be managed.

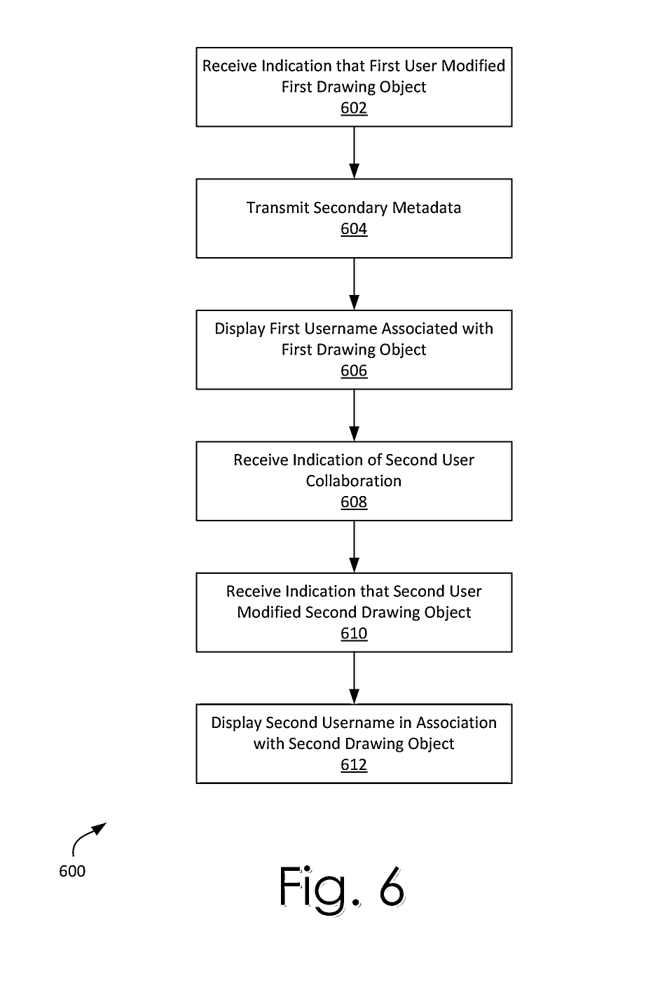

In some embodiments described herein, the server 104 is configured to manage a list of users of client devices accessing the drawing document 108 for coauthoring purposes. In the example explained above, for example, the server 104 would include a list of users of devices 102a, 102c, but would not include a user of device 102b in the list. As further discussed below in connection with FIGS. 6-7, the list of users associated with the drawing document can be used to share notifications of drawing modifications among current coauthors. Additionally, the list of users accessing the drawing document can include various contact information, so the coauthoring users can contact each other with questions or concerns about ways to resolve any potential conflicts between edits applied by each user.

In general, to achieve the conflict resolution and editing systems relative to a drawing object as described herein, maintenance of an original drawing is required, as well as maintenance of the edited drawings of each coauthoring user to determine when and where such conflicts take place. As illustrated in FIG. 2, a system 200 for managing coauthoring in a drawing tool is shown, according to an example embodiment. The system 200 generally includes a server storage and synchronization area 202 interfaced with a local document cache 204, such as would be provided in the client-server arrangement illustrated between any of the client computing devices 102 and server 104 of FIG. 1.

In the embodiment shown, the system 200 includes a server storage area 206 in which a copy of a drawing can be stored. The server storage area 206 can be, in such embodiments, a database or server workflow management system, such as SHAREPOINT® server software, also available from Microsoft Corporation. A client 102 can retrieve a download copy 208 of the drawing from the server storage area 206. The download copy 208 corresponds to a latest copy available in the server storage area 206. To preserve the client's knowledge of the current state of the document as maintained in the server storage area 202, a base copy 210 is created from the download copy 208, and represents the copy of the download that occurred after the last successful merge of the client and server copies took place (as further discussed below). A working copy 212 is also created from the download copy 208, and is used for local editing/modification by a user. As a user edits the working copy 212 of the drawing, that user may wish to upload his/her changes back to the server to be saved. That user can select a “save” option within a drawing tool, which will in turn create an upload copy 214 of the drawing, which can be returned to the server storage area 206.

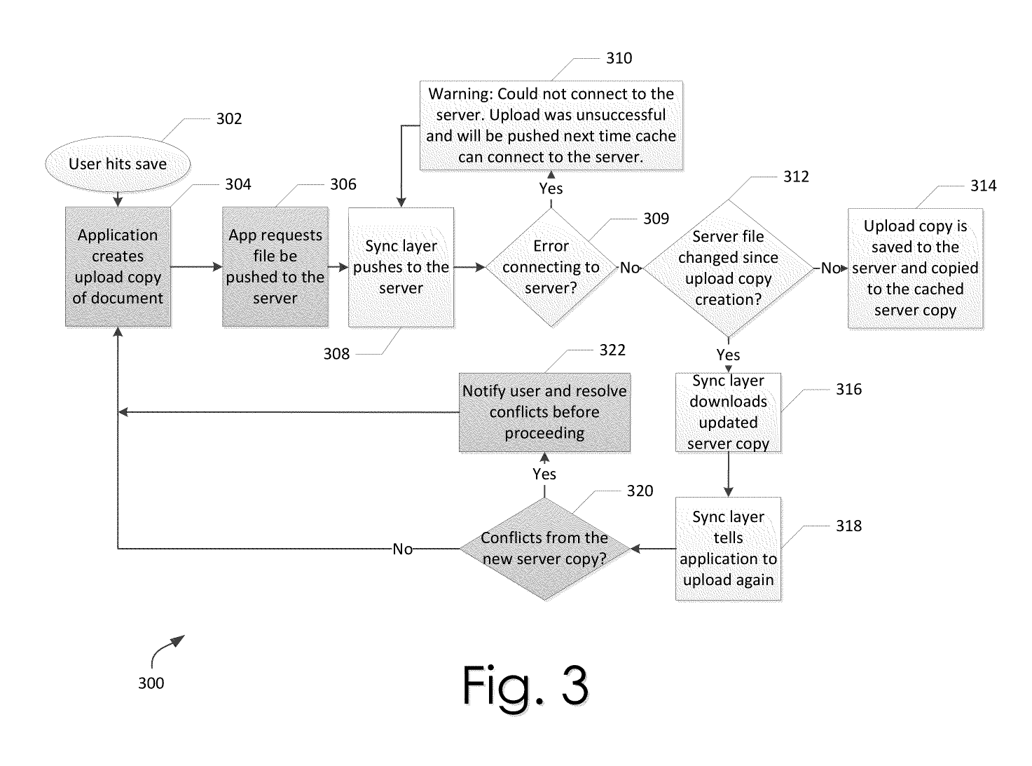

Although in general this process is straightforward when only a single user accesses the drawing from the server storage area 206, complexities arise when a second user concurrently requests the drawing from the server storage area 206, and changes the copy of the drawing in the server storage area between the time when the download copy 208 is created and when the upload copy 214 is returned to the server. To resolve such conflicts, a process for resolving conflicts in a coauthored drawing is performed. One example process 300 is illustrated in connection with FIG. 3.

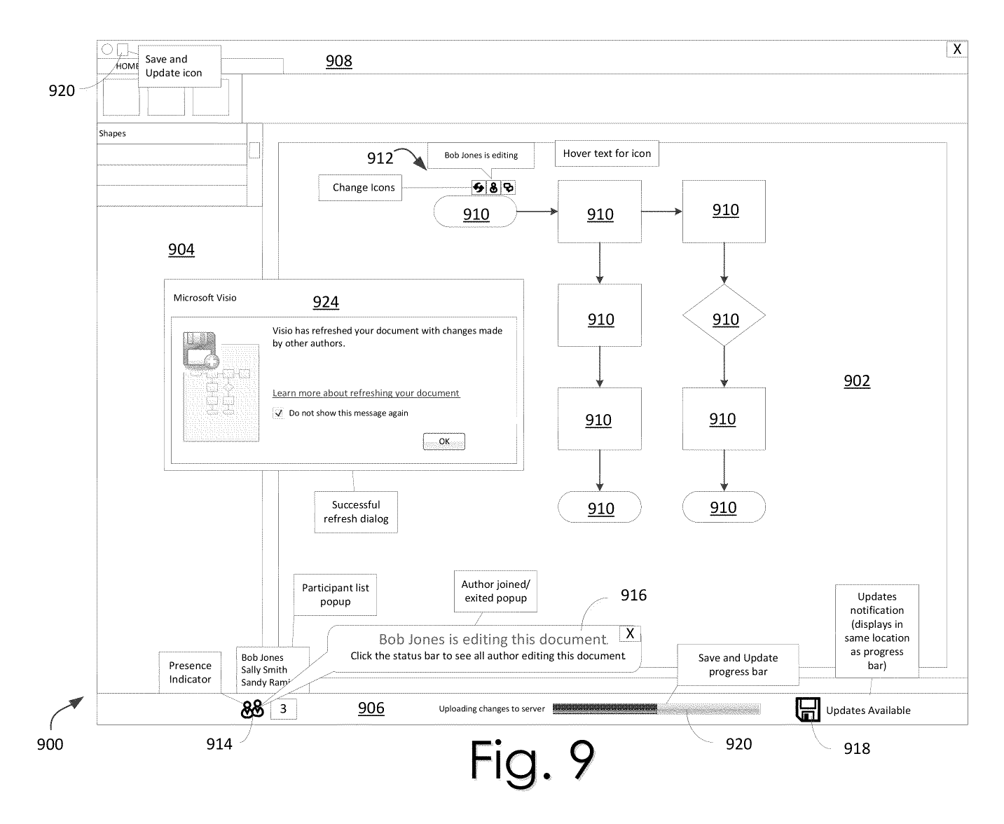

Referring now to FIG. 3, in the embodiment shown the process 300 is instantiated upon a local user of a client computing device electing to save the edits made in the drawing that user is working on (i.e., the working copy 212 of FIG. 2). In general, the shaded process steps can occur within a drawing tool itself, while unshaded process steps can occur either within the drawing tool or external to the drawing tool, for example within a larger application framework or operating system of the client computing device. In general, and as illustrated in the example user interface of FIG. 9, below when there are changes waiting to be synced the local author will be prompted to save and update the local version of the drawing document, and will see updated changes from other authors only after the save/update is complete.

In the embodiment shown, the client computing device receives the save request (step 302), and the drawing tool creates the upload copy 214 of the drawing (step 304). The drawing tool then requests to transmit the upload copy 214 to the server storage area 206 (step 306). A synchronization layer attempts to establish a connection to allow transmission of the drawing to the server (step 308). A determination may be made at step 309 to determine whether there may be an error connecting to the server. For example the client device may be disconnected from the server after the download copy 208 is created, such that the user has made a number of changes while entirely disconnected from the server. If a connection is not reestablished with the server, a failure operation will communicate a failure to save and merge changes into the server version of the drawing (step 310), and the connection can be retried, returning to step 308. If connection to the server storage area 206 is successful, a version number of the base copy 210 is compared to a version number of the copy of the drawing at the server storage area 206 to determine whether the version number of the copy at the server storage area 206 has changed, indicating whether any changes have occurred in the server copy since it was originally downloaded (step 312). If no changes have occurred, the upload copy 214 is saved to the server and copied over the cached server copy (step 314).

If changes have occurred such that the version number of the base copy 210 does not match a version number of the copy of the document stored at the server storage area 208, a merge process must be performed, to resolve any conflicts that may take place. Accordingly, the client device will download an updated version of the server copy of the drawing document (step 316), and again indicate to transmit the upload copy 214 to the server (step 318). The client application will compare the new server copy (i.e., the updated download copy 208 of the drawing document) to the base copy 210 of the drawing document to determine changes applied by other users, and will compare the upload copy 214 to the base copy 210 to determine all changes by the local user, and determine whether any conflicts between those modifications exist (e.g., modifications to the same attribute of the same drawing object, or overlapping placement of different drawing objects, as illustrated in FIG. 3) (step 320). If conflicts are located within the drawing tool, the drawing tool will resolve those conflicts by creating a new, merged working copy 212 including the remote changes and the local changes, as resolved (step 322), at which point the process restarts at step 304, creating an upload copy 214 and reattempting synchronization to the server storage area 206. The user can then be presented with the resolved copy of the drawing.

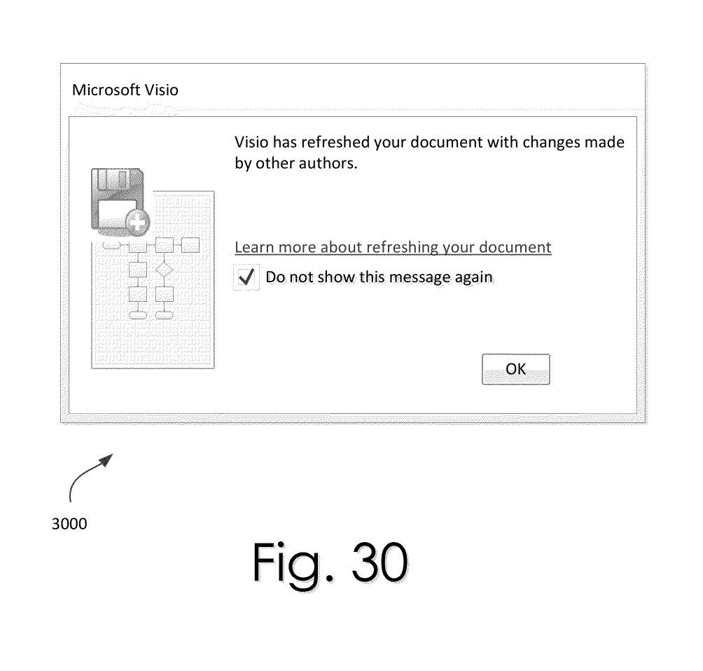

Referring specifically to step 322 of the process 300, it is recognized that merged working copy 212, which was created based on the download copy 208, base copy 210, and current working copy 212, is created based on a log of changes performed on the drawing document. Specifically, a merge process is performed based on a state of each drawing object in the drawing document; how the shape arrived at that state is immaterial to the merge process. As discussed further in connection with FIGS. 9 and 29, no changes to the drawing document are allowed during a merge process; additionally, regardless of the number of users affiliated with the document at a server (e.g., server 104), the client merges a local copy of the drawing document with the most recently saved or updated version of the drawing document at the server (as reflected in the download copy 208). Generally, merged modifications are managed on a “last in” basis, where a last-made change when the download and working copies of the drawing document are compared will take precedence where conflicts occur with respect to the same or overlapping drawing objects. Optionally, merge conflicts may require user intervention (e.g., in the case of overlapping drawing objects); in such circumstances, user intervention may be required.

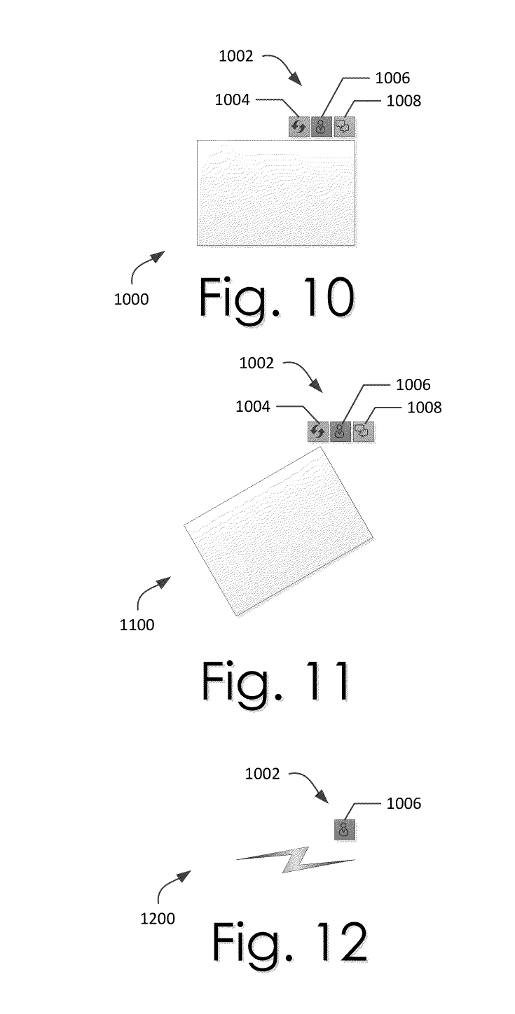

Generally, and as discussed below in conjunction with the user interface features of FIGS. 10-30, a user of a client computing system can be notified upon changes to a remote document, for example upon a successful update of the local document to the server storage area 206. Additionally, icons can be used to indicate areas that have been recently changed or currently edited by remote coauthoring users, as discussed in further detail in connection with FIG. 6-8.

Referring generally to the process 300 illustrated in FIG. 3, conflict resolution happens, if at all, on a client system, rather than at the server. This alleviates the potential issue of multiple clients uploading the same drawing to the server, and the server needing to resolve multiple sets of conflicts at once. Instead, each client resolves any conflicts created by the editing performed on that client device. Additionally, it can be seen that a user cannot save his/her own changes to the server without concurrently updating the local drawing document with changes represented in the server copy of the drawing document; likewise, the user cannot only view updates from other users without concurrently sharing his/her changes to the drawing document by electing to save the local drawing document back to the server.

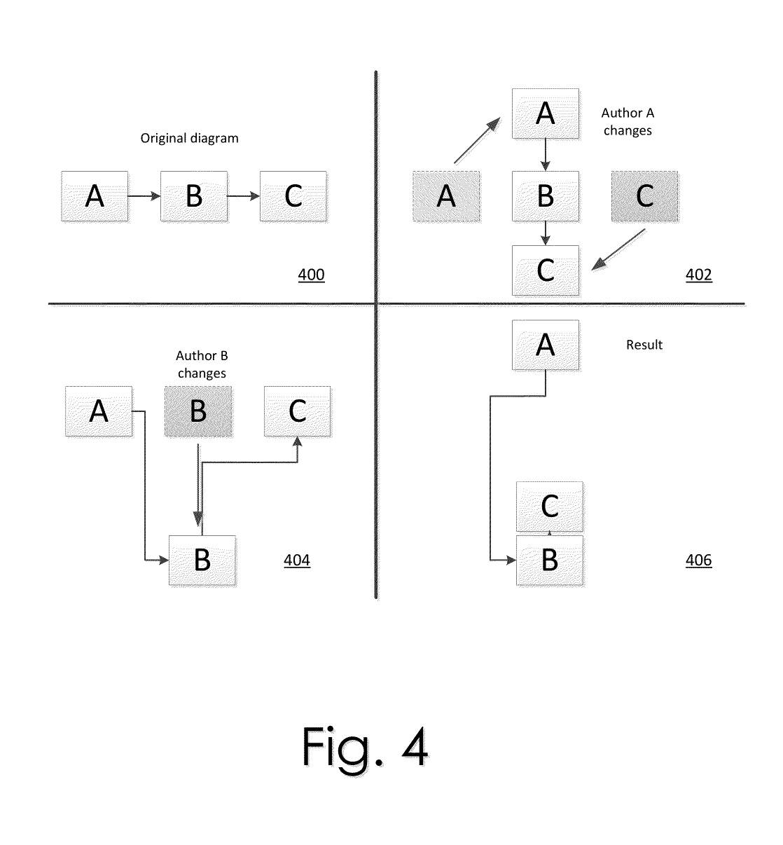

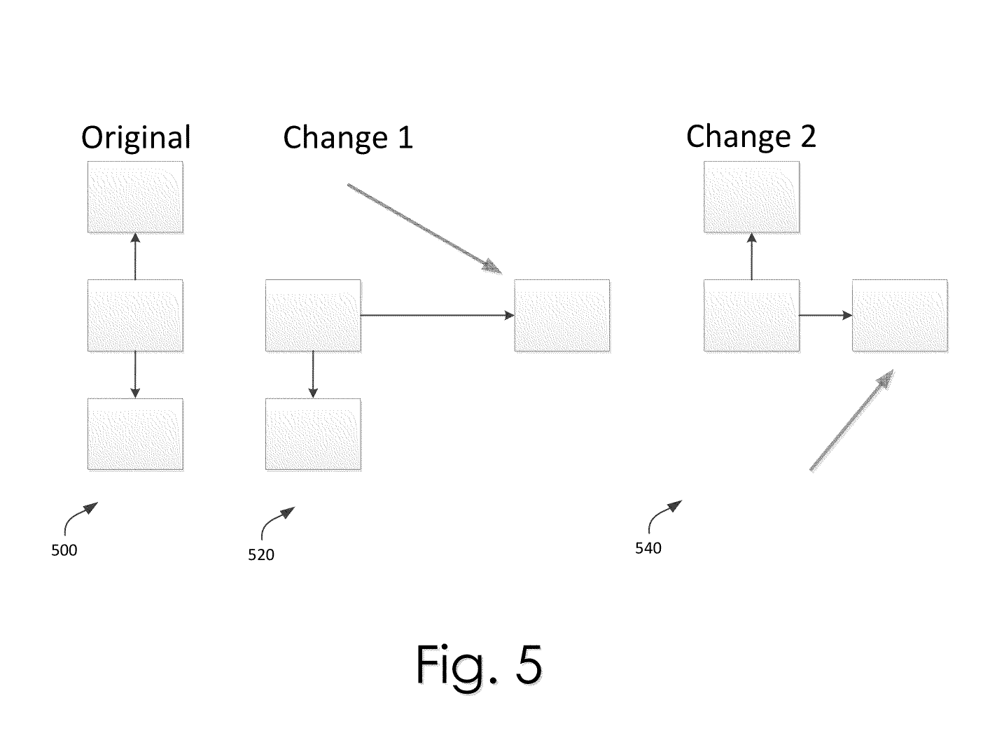

Referring now to FIGS. 4-5, example edits to a drawing are illustrated that are made by two different coauthor users. The examples illustrated in FIGS. 4-5 highlight possible issues encountered by allowing multiple users to edit a drawing document concurrently, as well as possible methods to resolve such conflicts.

In FIG. 4, an original drawing 400 is depicted, which is concurrently edited by a first user and a second user (e.g., users of client devices 102a, 102c). FIG. 4 is separated into quadrants, with the top left quadrant representing the original drawing 400; the top right quadrant representing a modified drawing 402 including drawing changes made by a first user, referred to as “Author A”, the bottom left quadrant representing a second modified drawing 404 including drawing changes made by a second user, referred to as “Author B”; and a lower right quadrant including a resulting drawing 406 representing resolution of the drawing changes by both first and second users. In this example, both the first and second users made drawing changes to the original drawing 400. While the first user made edits to two drawing objects “A” and “C” within the drawing (rearranging those two elements), the second user changed a position of one object “B” that is different from the objects modified by the first user.

In the example shown, regardless of the order in which the edits are made, because the first and second users only edited separate objects, the resulting drawing 406 includes a reordered drawing in which the “B” object is moved downward, and the “A” and “C” objects are moved into a vertical orientation. Each of the connections between the objects (i.e., “A” connects to “B”, which in turn connects to “C”) are maintained.

Referring now to FIG. 5, a slightly more complex example is illustrated, where although two users do not edit the same drawing object; they edit two different drawing objects such that the objects completely overlap. In this example, an original drawing 500 includes three drawing objects in a vertical orientation. A first user can edit the drawing to move a topmost drawing object to a horizontal position relative to the middle object, as illustrated in drawing 520. Concurrently (or at least before resynchronization of the first user's edits to the drawing), a second user can edit the drawing to move the bottommost drawing object to a horizontal position relative to the middle object, shown in drawing 540.

In this example, although users are not attempting to edit the same drawing object, it is unlikely that the users wish to have their edited objects placed directly superimposed over each other. In some embodiments discussed herein, resolution of this conflict may take a variety of forms; in one example, one of the topmost and bottommost objects from the original drawing 500 can be offset from the position to which it is moved, to allow all of the objects to be visible. Alternatively, one or both of the edits made by the first and second user (shown in drawings 520, 540) could be rejected. Other methods of conflict resolution are possible as well.

In some circumstances, user interaction may be required to resolve conflicts. For example, such a conflict may occur when the changes of one author completely eliminates the work of a second coauthor. A common instance of this might be when a first user deletes a shape and saves/updates while a second user continues to make changes to that shape. In order to avoid a change that is perceived as data loss, it is preferably to allow the author whose changes were lost the opportunity to preserve the changes. Accordingly, a merge process performed according to certain embodiments of the present disclosure provides for a modified merge in which deleted items are marked for deletion rather than deleted, allowing editors of those objects to confirm that deletion is desired.

Although in FIG. 5 one example of a type of conflict is illustrated, other conflict types could occur as well, particularly in more complex drawing and design software. For example the first and second users could elect to modify the size, position, color, or other attribute of the same drawing object, rather than superimposing different drawing objects on each other. In VISIO® drawing and layout software, drawing objects are generally shapes made from a series of cells, each of which represent properties of that shape. Example properties of a particular drawing object include: foreground color, background color, line style, fill style, position, references to other shapes, connection points, geometrical lines within a shape, and other features. In the context of the present disclosure, conflict resolution among drawing objects can be performed on an attribute-by-attribute basis, rather than on an object-by-object basis. Accordingly, if a first user changes text on a shape, while a second user changes the background color of that same shape; those modifications to the same drawing object could be merged without conflict. However, inconsistent actions on the same shape or attribute (e.g., two movements of the same shape, or a move and a resizing operation) would result in an unexpected result; in these cases, the attributes of a particular drawing object are interrelated, and the entire drawing object is treated as a whole for that purpose.

In some cases collisions among drawing objects cannot easily be merged, while in other cases, collisions can be resolved. Example types of collisions include false collisions, change collisions, catastrophic collisions, deletion conflicts, and un-mergeable conflicts. A false collision relates to changes to a single drawing object by multiple users that will merge without unexpected behavior, for example where a first user changes a position of the shape while a second user changes the color of that same shape. A change collision relates to changes that appear to represent a conflict, but can be resolved on a “last edit wins” basis, such as first and second users moving the same object. In a further type of collision, called a “catastrophic” or deletion collision, data loss would result in an unacceptable and unrecoverable manner; as such, deleted or colliding elements could be saved in a separate file. Other types of conflicts may exist as well. In sum, because it is difficult to determine whether desired actions on a particular drawing object may or may not be a conflict, those decisions are not limited by the drawing software, but are instead managed by the coauthors themselves by communicating coauthoring information between those coauthors.

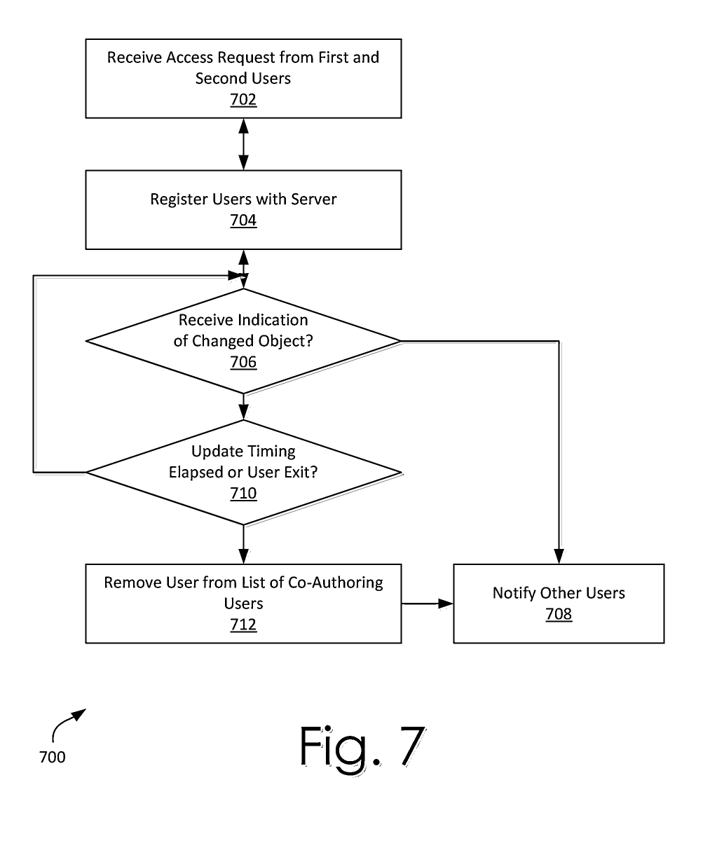

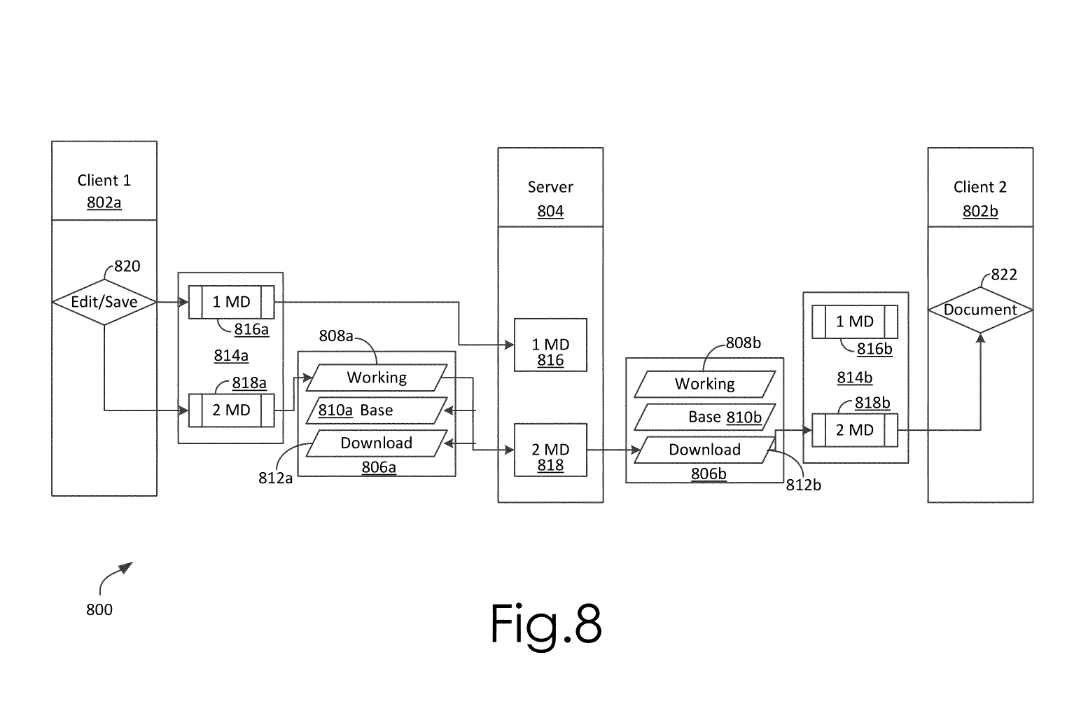

To facilitate communication among coauthors to minimize conflicts, as illustrated in further detail in connection with FIGS. 6-8, details regarding communication of changes among such coauthors are shown. FIG. 6 illustrates an example method 600 of notifying a coauthor using a client computing system about changes occurring on a remote client, e.g., by another coauthor. In method 600, the client computing system receives an indication that a first user modified a first drawing object (step 602). This may, for example, correspond to receipt of a local modification of a drawing object by that first user. In such circumstances, the client computing system transmits a set of metadata to the server for distribution to other coauthoring users currently registered as editing the document (step 604). In the embodiment shown, this metadata is referred to as “secondary metadata” in that it represents information about changes that have occurred on the client computing system since the last successful merge has taken place. As discussed in further detail in connection with FIG. 7, a server can receive this secondary metadata and redistribute it to other coauthoring users, so drawing tools at other client devices can display notifications about edited drawing objects. Primary metadata, on the other hand, refers to metadata saved at the same time the user saves and merges changes from other users, i.e., from the server. So at any given time the primary metadata includes all the changes that other users have made, but that have already been incorporated into the local drawing document. Additional description of primary and secondary metadata is provided below in connection with FIG. 8.

In the embodiment shown, method 600 continues with displaying a first username associated with a first drawing object (step 606). The first username can be, for example, a username of the local user, and can be included in a graphical notification feature that the user has edited the particular drawing object. Details regarding notification features are provided in further detail in FIGS. 9-22, below.

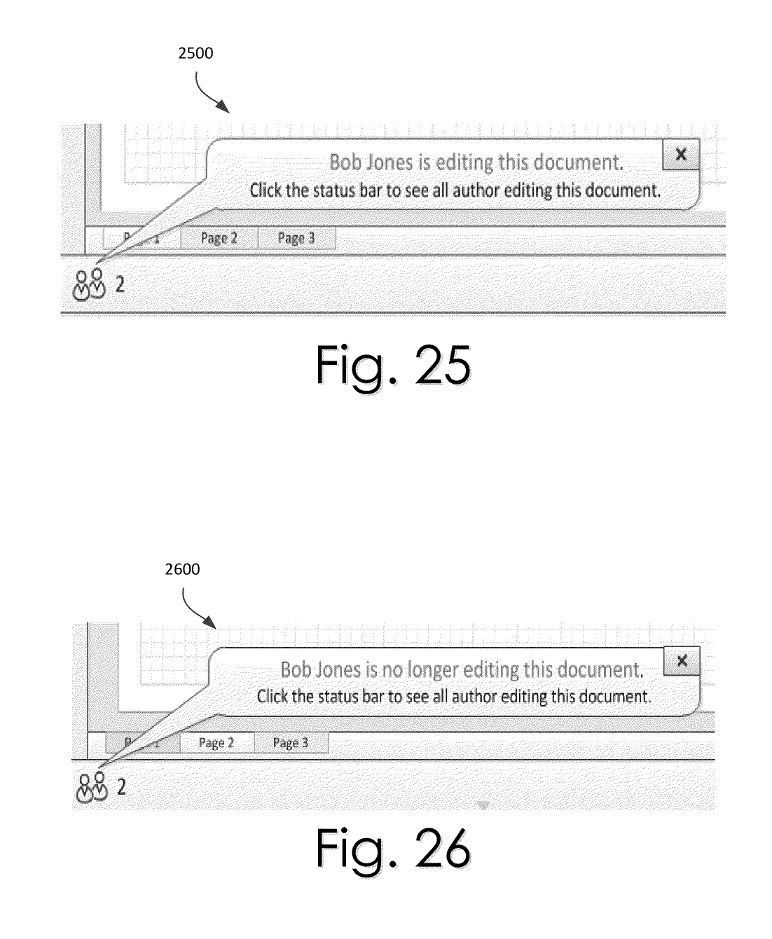

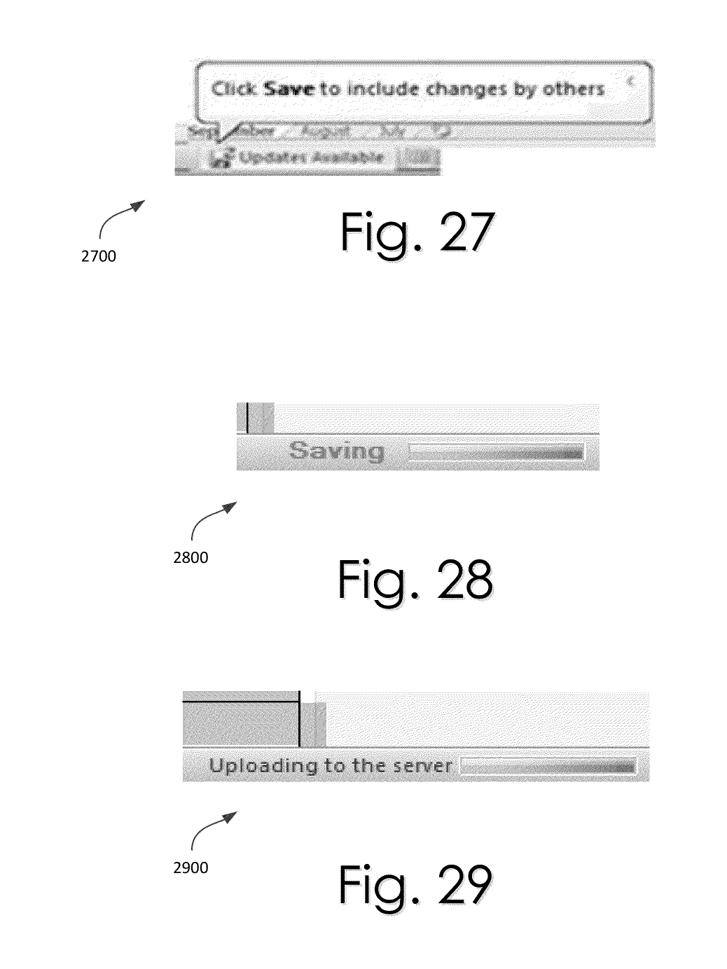

The client computing system can, in the embodiment shown, also receive an indication that a second user is collaborating with the user of the client computing system on the drawing document (step 608). This notification can take many forms. For example, the notification can be associated with the document as a whole, and can be paired with a notification presented to the user of the client computing system when another user either enters or exits the drawing document (e.g., as illustrated in FIGS. 25-26). Alternatively, the notification can be associated with a portion of the document, such as a drawing object, or can simply indicate that changes are available for merger, rather than identifying the other user specifically (e.g., as indicated in the notification of FIG. 27). Other types of notifications are possible as well.

In various embodiments, the client computing system can receive notifications in a variety of ways. In a particular embodiment, for some notifications the client computing system is configured to periodically poll a server to determine if any changes have occurred to a saved version of the document. For other notifications, those notifications may be proactively sent to the client computing system from the server.

In the embodiment shown, method 600 continues with receiving an indication that a second user, such as a remote coauthor, has modified a second drawing object, different from the drawing object edited by the local user (step 610). In this embodiment, the indication can correspond to secondary metadata generated at the remote coauthor's client device, and routed to the client computing device via the server (e.g., server 102). In accordance with the present disclosure, in typical embodiments the secondary metadata includes information about the drawing object being edited by the second user, as well as the time those edits occurred. The second user's username can then be displayed in association with the second drawing object (i.e., the drawing object edited by that second user) (step 612).

Referring now to FIG. 7, a flowchart illustrating a method 700 for managing notifications of users regarding notifications to a drawing applied by coauthor users is described. The method 700 can be performed, for example, by a server such as server 104 of FIG. 1, which manages access to and a list of users accessing a particular drawing object.

In the embodiment shown, the method 700 includes receiving access requests from two or more users, such that at least two users are accessing a drawing document at the same time (i.e., are coauthors) (step 702). Each access request by a user is registered with the server (step 704), such that the server manages a list of coauthors currently accessing any particular drawing document.

As each of the coauthors, at different client devices, edit or modify objects in the drawing document, metadata is transmitted back to the server (step 706). In the embodiment shown, the metadata indicates the object that was modified and the time at which the modification took place. If the server receives such metadata, it notifies other users (besides the user of the client device that transmitted the metadata), for example by relaying the metadata to those other registered users/client devices (step 708). If no changes occurred, no notification would consequently take place.

In addition, in some embodiments the server manages a timer, to monitor a time elapsed since the last edits are received from a particular user. If a user has not edited a drawing document within a predetermined time or if that user has closed the document on that user's client computing system (step 710), that user can be removed from a list of current users of the drawing document (step 712). Other coauthoring users, besides that user that is removed, can be notified of this even, as indicated in step 708. If no update timing has elapsed, the server can continue to monitor to receive metadata regarding changes to drawing objects from one or more of the coauthor users.

Referring now to FIGS. 6-7 generally, it can be seen that by updating coauthor users with metadata, the fact of a first user editing of a particular drawing object can be communicated back to other users without requiring that all of the details of what that editing entails be communicated. This allows for quick updating of each of the coauthoring users regarding edits that are applied, so coauthoring users can elect to avoid editing or modifying the same object being modified by that first user, if so desired. However, each of the coauthor users is generally presented with information regarding possible overlapping edits without locking drawings or drawing objects for dedicated edits by one particular user, thereby improving the flexibility with which edits can be entered using the drawing tool. Additionally, and referring to FIGS. 6-7 generally, although a particular order of operations are described in connection with these figures, it is understood that a different order of operations could be performed as well.

FIG. 8 is a schematic diagram illustrating a system 800 in which updates are applied to drawing files and related metadata at first and second client computing systems and a server computing system, according to an example embodiment. The system 800 generally represents the overall data flow for either a modification of a drawing, or a user electing to save his/her edits, such that they can be propagated to coauthors.

In the embodiment shown, a first client device 802a and a second client device 802b are communicatively connected to a server 804. The first client device 802a and the second client device 802b each have a local drawing document 806a-b, derived from a copy stored at the server 804. In accordance with the present disclosure, each local drawing document 806a-b includes, at the client devices 802a-b, a working copy 808a-b, a base copy 810a-b, and a download copy 812a-b, respectively. The working copy 808a-b, base copy 810a-b, and download copy 812a-b can, in certain embodiments, correspond to analogous elements 808-812 of FIG. 2.

Additionally, each of the drawing documents 806a-b are associated with metadata 814a-b, which includes primary metadata 816a-b and secondary metadata 818a-b, respectively (alternatively, primary metadata 816 and secondary metadata 818 in the abstract, or as stored on the server 804). The metadata 814 is used to track changes between the client and server versions of the documents, to properly merge modifications and to drive the user interface (as illustrated in FIGS. 6-7) to inform a local coauthor of document objects that are currently being edited by other coauthors and of changes which have been received during the merge. The primary metadata 816 refers to metadata saved at the same time the user (e.g., the user of the first client device 802a) saves and merges changes to the server 804, and is a list of changes that have been made and committed to the server. The primary metadata 816 is downloaded every time the download copy 812a is received locally at the client device (e.g., device 802a). The secondary metadata 818 represents information about changes that have occurred on the local computing system since the last successful merge has taken place, and includes information to track all changes that have been made without the content changes themselves. The difference between primary metadata 816 and secondary metadata 818 represents the un-merged changes that are in the document. In the examples described herein, the first client device 802a is generally considered to be the device at which edits are entered; however it is understood that in accordance with the principles discussed herein, an analogous process could be concurrently occurring in a reverse direction.

As shown, an edit or save operation 820 can be elected by a user of the first client device 802a. If a save operation is elected, primary metadata 816a associated with the first local drawing document 806a is propagated to the server 804 and stored as metadata 816, along with changes to the document 808a, which are dictated by a merge operation executed at the first client device 802a (e.g., as explained above in connection with FIG. 3). If an edit operation is elected by the user of the first client device 802a, secondary metadata is generated in response to any edit of the working copy 808a of the drawing document 806a. The secondary metadata is propagated to the server 804, for communication to the second client device 804. In the case of either primary metadata 816 or secondary metadata 818, the metadata 816 as a whole is written to the server 804 sorted by timestamp.

Additionally, if a save operation is elected, secondary metadata is transmitted to the server, and a merge operation causes modification of the download copy 812a and base copy 810a of the drawing document 806a, with the secondary metadata essentially becoming part of the primary metadata at that point, once changes reflected in the secondary metadata are committed to the server 804. The secondary metadata, representing changes to the drawing document 806, can be used to update a document 822 at a second client device 802b.

Notably, the metadata 816 is maintained separately from the merge process described above in connection with FIGS. 2-3; instead, it is used as a basis to determine what user interface feedback to provide to a user based on changes set forth by other coauthoring users. Although in various embodiments different types of metadata can be tracked, in some embodiments, the metadata can include information about a drawing object within a drawing, including Deleted, Page ID, Shape ID, Author ID and Timestamp (GTC) properties. Other properties could be tracked using the metadata as well.

FIG. 9 is an example user interface 900 illustrating notifications presented to a user of a drawing tool supporting coauthoring, according to an example embodiment. The user interface 900 can, in various embodiments, be presented to a user at a client computing system, and illustrates a number of features, including notification features, available within the drawing tool to facilitate coauthoring. In the embodiment shown, the user interface includes a drawing panel 902 and a side panel 904, as well as a toolbar 906 along a bottom edge of the user interface and a ribbon panel 908 along a top edge of the drawing panel 902 and side panel 904.

In the embodiment shown, the drawing panel 902 displays a plurality of drawing objects 910, as are known to be displayed by a drawing tool. Additionally, associated with one or more of the drawing objects 910 is a notification feature 912. The notification feature 912 displays to the user of the drawing tool information regarding changes made by other coauthors. As further discussed below in connection with FIGS. 10-22, the notification feature can include, for example, information indicating that a drawing object has been changed, as well as a list of users currently editing the drawing object. Additionally, the notification feature 912 can include one or more comments entered by a viewer or coauthor of the document.

In the toolbar 906, a number of additional indicators are available to display a status of sharing of the drawing with other coauthors. In the example shown, a presence indicator 914 presents an icon associated with a number of users currently accessing the drawing document. The presence indicator 914 optionally also includes a list of names of those users (e.g., if user causes the mouse to hover over the icon). Additionally, as changes occur within the list of names, one or more pop-up balloons 916 notifying the user of changes to the list of users can be displayed as well. Examples of pop-up balloons 916 are provided below in connection with FIGS. 25-26.

Additionally within the toolbar 906, an updates indicator 918 can be displayed when updates are available in the server version of the drawing document. To view these updates, the user is prompted to click on the updates indicator 918 to save the local changes made by that user, starting a merge process as discussed above in connection with FIGS. 3-5. When a user initiates a merge process, a status bar 920 can be presented in the toolbar 906 as well, to illustrate to the user the state of merging of updates and modifications to the drawing document. Additionally, within the ribbon panel 908, a save and update icon 920 can also be used to initiate the merge process previously discussed. A pop-up window 924 illustrates a message communicated to the user, indicating that the save and update process has completed.

Referring now to FIGS. 10-22 generally, additional details regarding notification features associated with drawing objects are illustrated. In general, the notification features illustrated in these figures are affiliated with specific drawing objects, indicating that the drawing object is in use or is otherwise edited by a user. FIGS. 10-12 generally illustrate a drawing object with an associated notification feature 1002. The notification feature 1002, in each example, includes a plurality of fields, including an update notification field 1004, a coauthor notification field 1006, and a comment notification field 1008. The notification field 1004 is displayed after updates are saved, to indicate that an object has been changed since the last update. Once a user edits the drawing object, the notification field 1004 is presented to each of the other coauthors during metadata updates. The notification field 1004 remains in place for all remote author users until that remote author has uploaded and merged his/her own changes with the change reflected by the notification field 1004.

In various embodiments, the update notification field 1004 and coauthor notification field 1006 are periodically updated, for example based on a polling operation where a drawing tool on a client computing device queries a server to determine the presence of any changes on the server. While the update notification field 1004 is based on metadata received at the server from various coauthors, the coauthor notification field 1006 is based on a difference between a base copy and a downloaded copy of the document. The coauthor notification field is therefore generated based on recent changes committed by remote authors. Generally, when a coauthor edits a drawing object, the update notification field 1004 can be generated based at least in part on detection of that change; when the coauthor saves his/her changes, that update notification field 1004 can disappear and the coauthor notification field 1006 will replace it. This allows other coauthors to continually view who has been editing a document (via the update notification field 1004), but only see those edits that a coauthor has actually committed to saving (via the coauthor notification field 1006).

FIGS. 10-12 also illustrate positioning of the notification feature 1002 relative to different drawing objects. In FIG. 10, the notification feature 1002 is presented along a top right corner of a drawing object 1000. In FIG. 11, representing a rotated version 1100 of the drawing object 1000, the notification feature 1002 is presented along an upper right corner as well. In FIG. 12, the drawing object 1200 includes a notification feature 1002 also in geometrically upper right position.

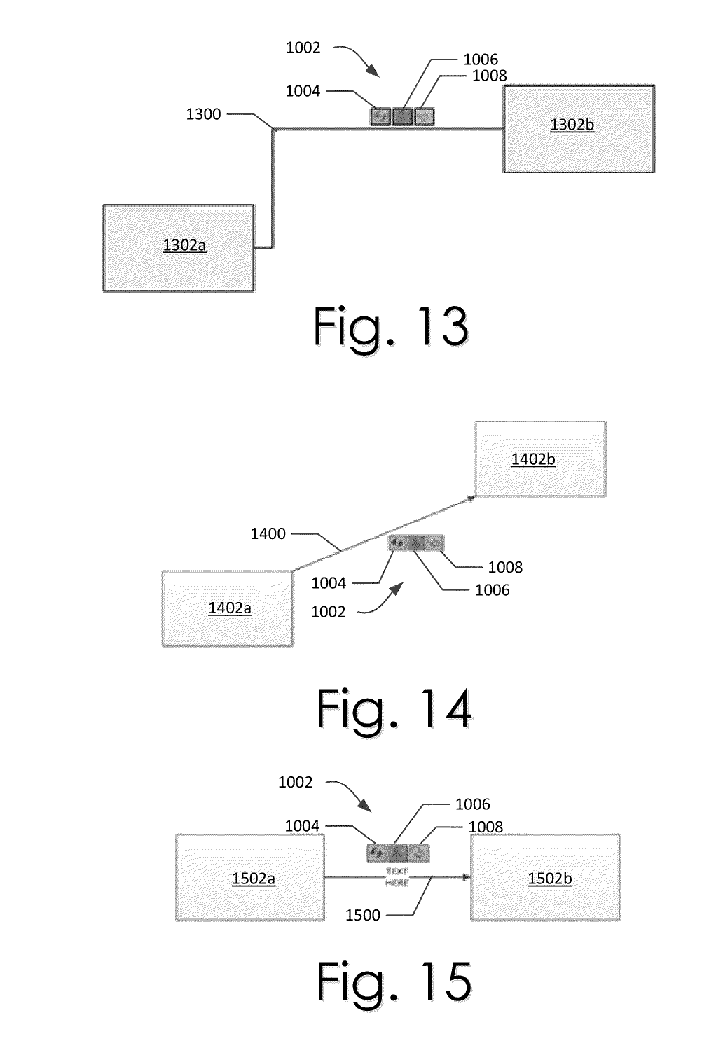

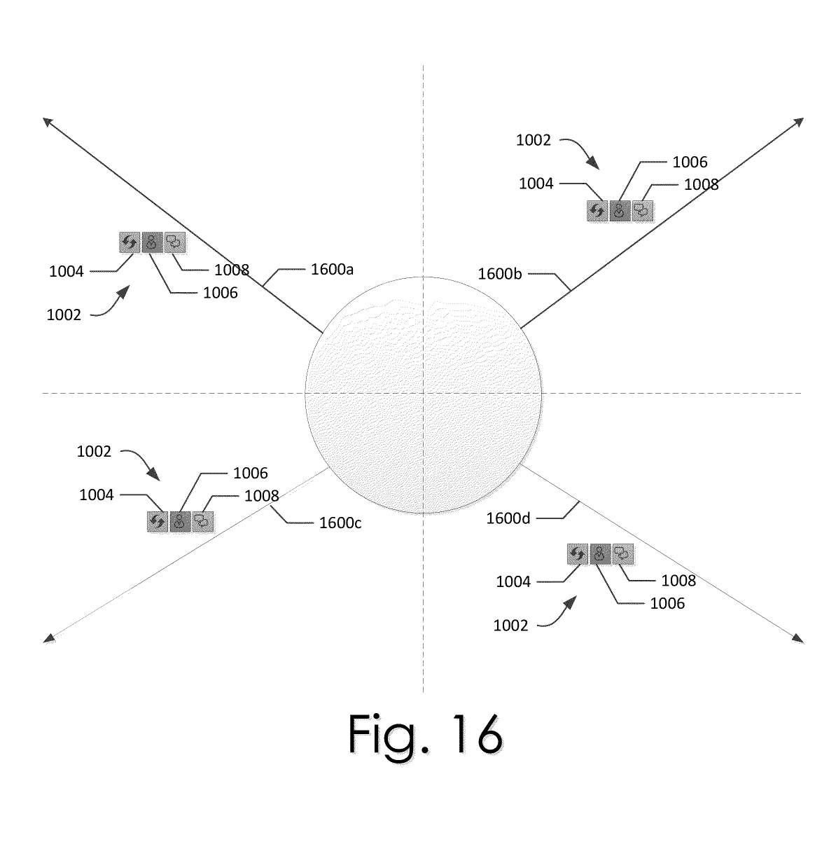

Referring to FIGS. 13-16, example locations for the notification feature 1002 along a connector between two objects are shown. In FIG. 13, the notification feature 1002 is presented along a midpoint of a longest horizontal segment of a connector 1300 between two objects 1302a-b. In FIG. 14, where the connector 1400 shown is a straight arrow between two objects 1402a-b, the notification feature 1002 is presented at the midpoint, below the connector 1400. In FIG. 15, which illustrates a connector 1500 with associated text between two objects 1502a-b, the notification feature 1002 is presented above the text at a midpoint of the connector. FIG. 16 illustrates an example layout of notification features 1002 in association with connectors 1600a-d; the position of the notification feature associated with each connector is based on the orientation and angle of the connector with which it is associated.

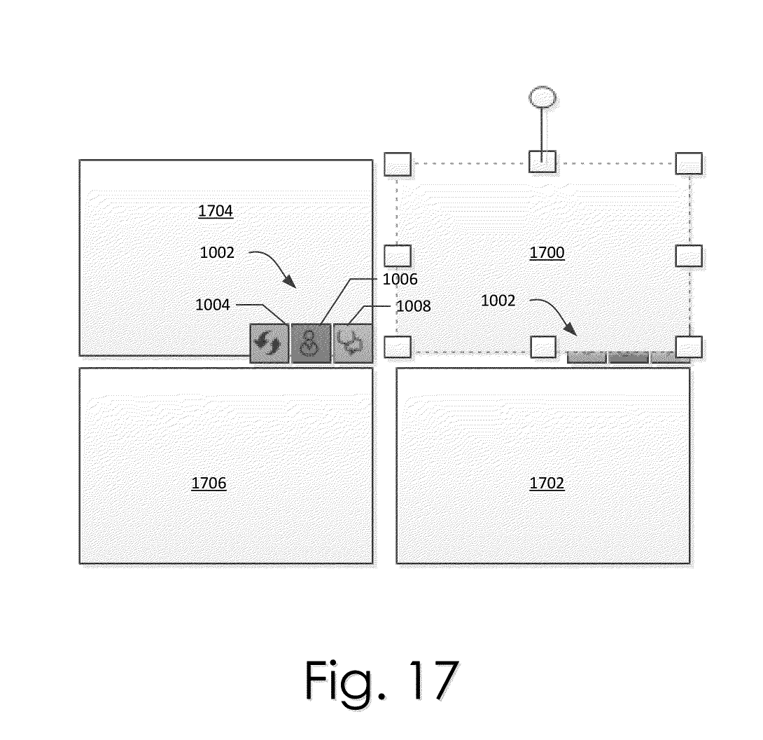

As illustrated in FIG. 17, the notification features 1002 presented in a drawing panel generally will not interfere with other adjacent shapes, because, as illustrated in this figure, an active shape 1700 will be brought to the front, and the notification feature 1002 associated with an adjacent object 1702 presented behind that active shape 1700. In contrast, when the shape with which the notification feature overlaps is not selected, the notification feature is brought to the front of the adjacent object (e.g., as illustrated in the two leftmost objects 1704-1706 in the figure).

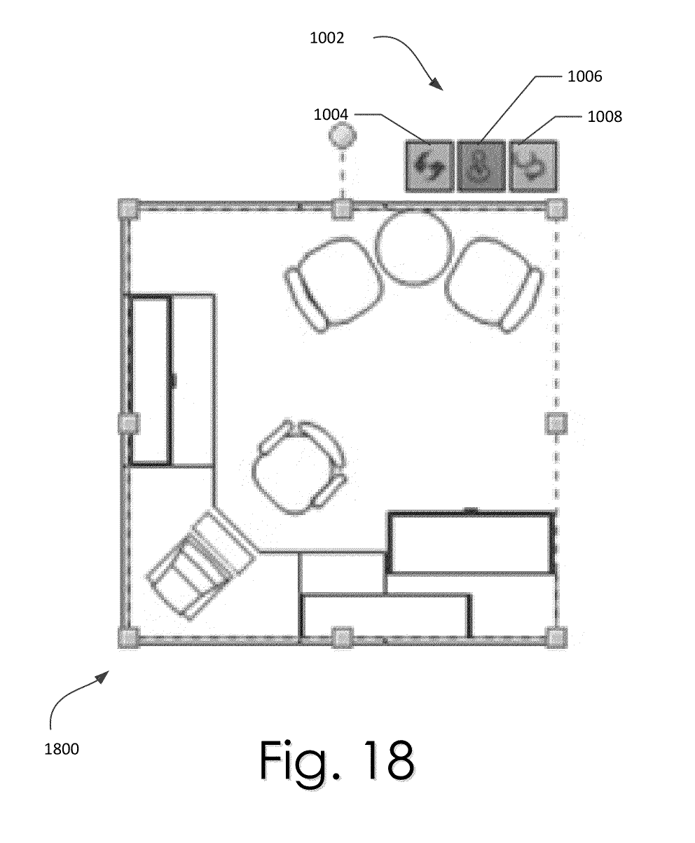

In FIG. 18, a notification feature 1002 is presented in association with a group object 1800 (illustrated as a cubicle). In this arrangement, the group object has been previously grouped by the drawing took; accordingly any change to a sub-element of the object 1800 is propagated as a change to the object overall, and the notification feature 1002 is updated accordingly.

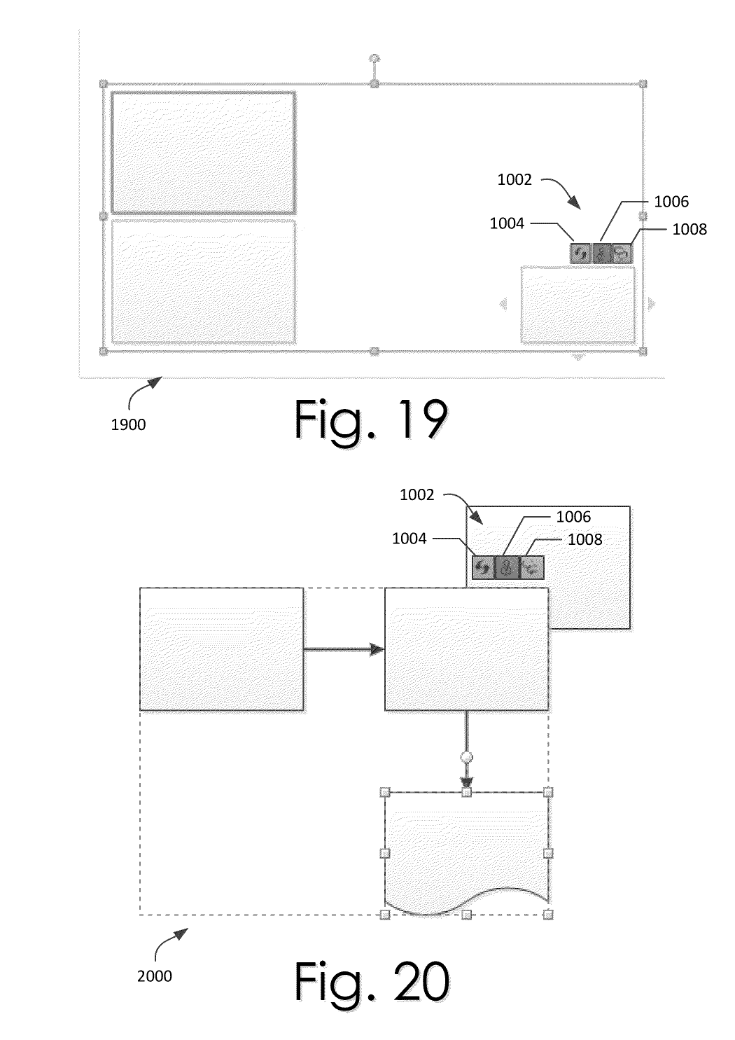

In contrast, in FIGS. 19-20, the notification feature 1002 is associated with a manually grouped set of objects 1900; in such arrangements the notification feature is displayed on the sub-object of that group, rather than for the group overall. However, as illustrated in FIG. 20, when the group 2000 is selected, placement of the notification feature follows the “bring to front” and “send to back” features as illustrated in FIG. 17.

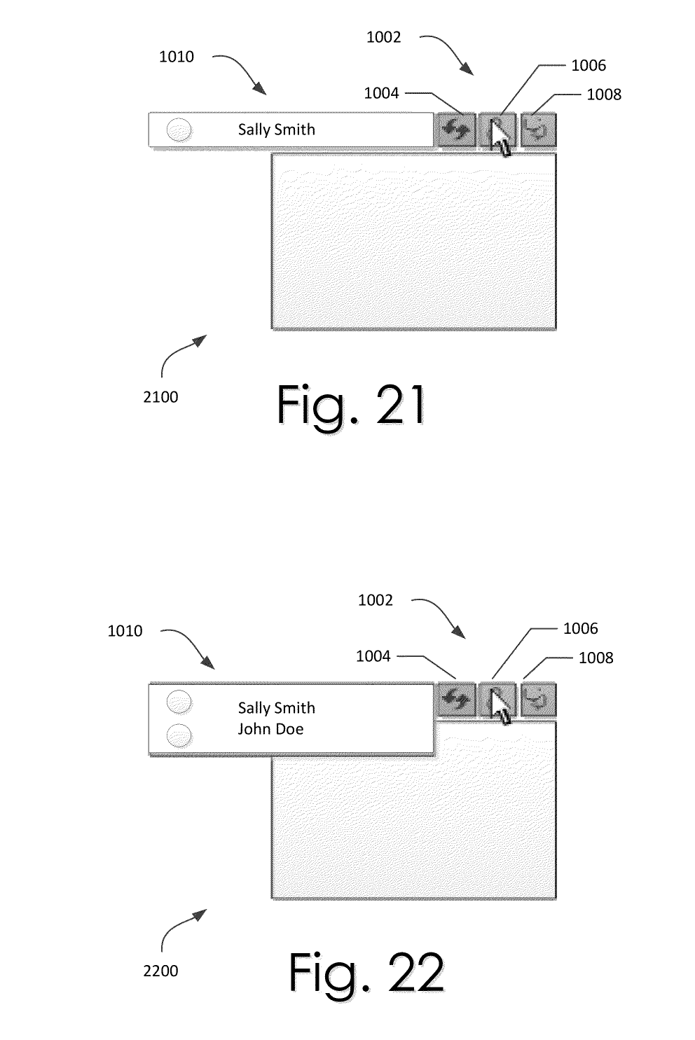

Referring to FIGS. 21-22, additional details regarding information presented by a notification feature 1002 are illustrated. As shown in FIGS. 21-22, by hovering over the update notification field 1004 or coauthor notification field 1006, a list 1010 of users who either have edited or are editing the drawing object 2100, 2200, respectively, are illustrated.

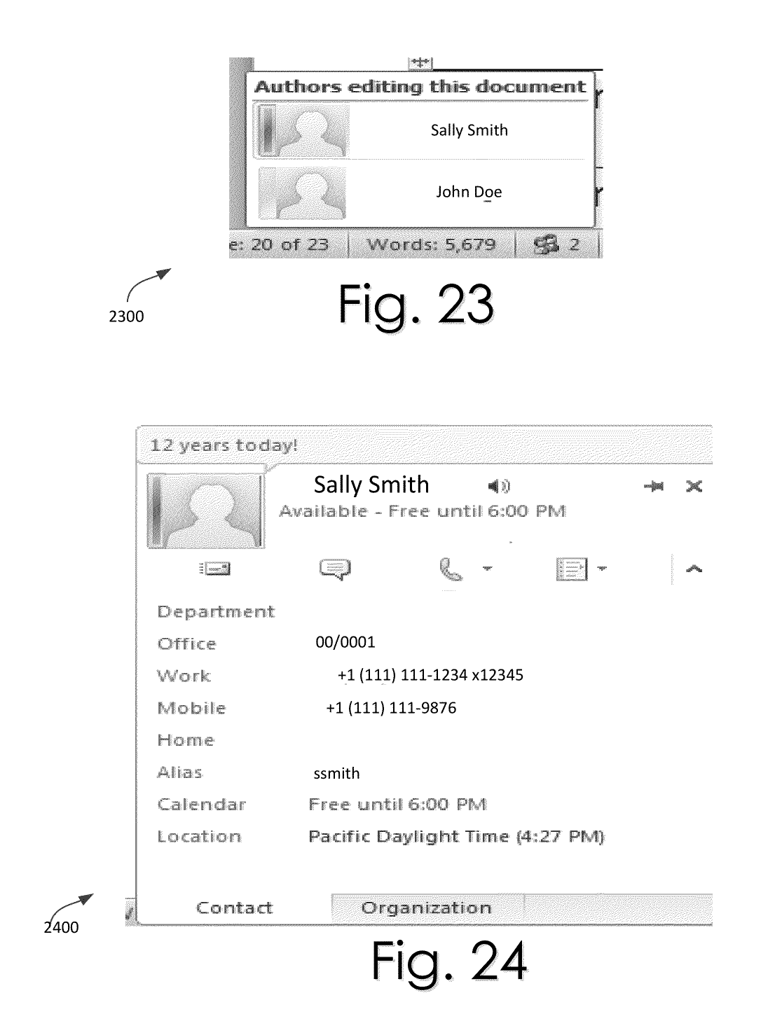

Referring now to FIGS. 23-26, additional notifications are shown that illustrate notifications of a list of users currently editing the drawing document. FIG. 23 illustrates a portion of a user interface 2300 that lists all coauthors currently editing the document, and FIG. 24 illustrates a further user interface 2400 that presents contact information of a user selected from the list illustrated in user interface 2300. Using these interfaces, it is possible to view and communicate with other users editing a drawing document, for example to discuss avoidance of conflicts as both coauthors edit the drawing document. FIGS. 25-26 illustrate updates from the drawing tool overall, indicating when a particular coauthor user is registered with the server as accessing the drawing document. While FIG. 25 illustrates a message 2500 associated with a coauthor user first accessing the document (or coming back online from a period of being offline), FIG. 26 illustrates a message 2600 associated with a user leaving the document, either by closing the document or by a timeout process managed by the server.

Referring now to FIGS. 27-30, various notifications within a user interface are illustrated which present information relating to the merge process outlined above in connection with FIGS. 3 and 8. FIG. 27 illustrates an example of a notification 2700 available in a user interface of a drawing tool indicating that changes committed to a drawing by coauthors are available for integration into a local copy of the drawing. The notification 2700 highlights a “save” option within the user interface that will trigger a merge operation, as discussed above in connection with FIG. 3 (e.g., at step 302). FIG. 28 illustrates a progress bar 2800 presented in a user interface of a drawing tool indicating that local changes are being resolved in the drawing, for example during execution of the merge process of FIG. 3. FIG. 29 illustrates a progress bar 2900 presented in a user interface of a drawing tool indicating that changes committed in the local copy of a drawing are being communicated to a server upon merger of the changes (e.g., in step 314). Finally, FIG. 30 illustrates a notification window 3000 presented to a user of a drawing tool upon synchronization at a client computing system of modifications to the drawing made by coauthors. The notification window 3000 can be presented to a user of a client device upon successful completion of a merge operation, as described above in connection with FIG. 3 (e.g., following step 314).

Although the notifications provided in FIGS. 27-30 illustrate one example graphical depiction communicating status of a merge process to a local user, it is recognized that various other graphical depictions of such status could be used as well.

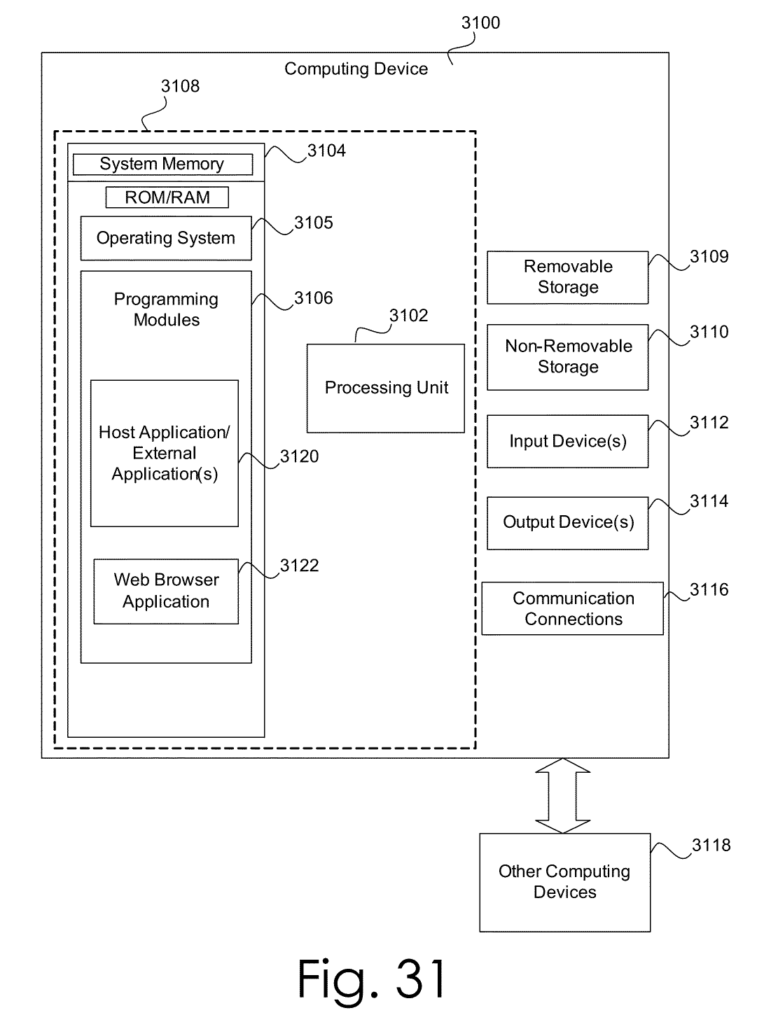

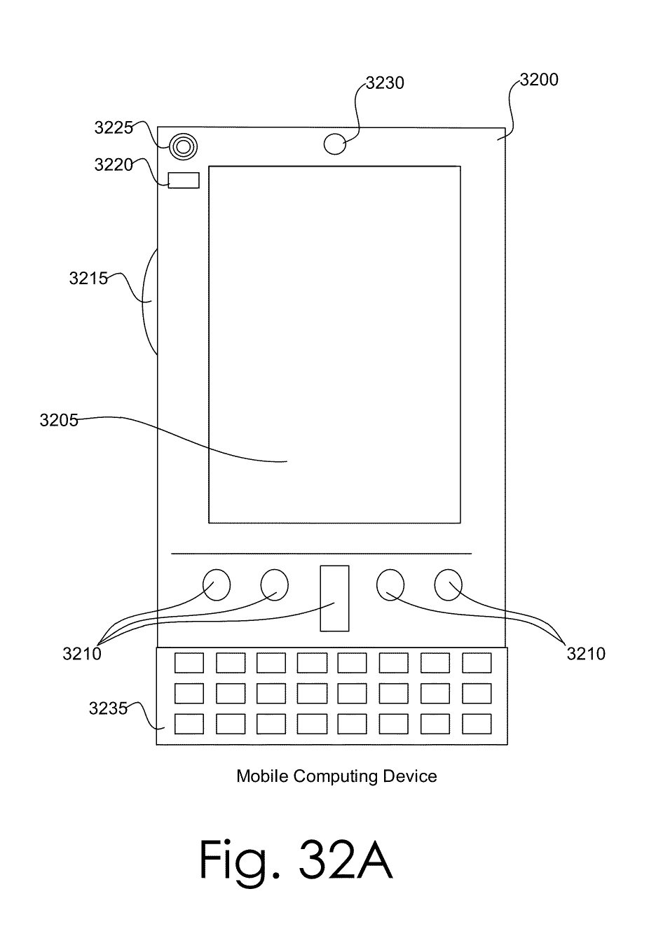

The embodiments and functionalities described herein may operate via a multitude of computing systems such as the server 104, and the client devices 102 described above with reference to FIG. 1, including wired and wireless computing systems, mobile computing systems (e.g., mobile telephones, tablet or slate type computers, laptop computers, etc.). In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. FIGS. 31 through 33 and the associated descriptions provide a discussion of a variety of operating environments in which embodiments of the invention may be practiced. However, the devices and systems illustrated and discussed with respect to FIGS. 31 through 33 are for purposes of example and illustration and are not limiting of a vast number of computing device configurations that may be utilized for practicing embodiments of the invention, described herein.

FIG. 31 is a block diagram illustrating example physical components of a computing device 3100 with which embodiments of the invention may be practiced. The computing device components described below may be suitable for the computing devices described above, for example, the server 104 or client computing devices 102. In a basic configuration, computing device 3100 may include at least one processing unit 3102 and a system memory 3104. Depending on the configuration and type of computing device, system memory 3104 may comprise, but is not limited to, volatile (e.g. random access memory (RAM)), non-volatile (e.g. read-only memory (ROM)), flash memory, or any combination. System memory 3104 may include operating system 3105 and one or more programming modules 3106, which are suitable for running applications such as application(s) and client application (e.g., a user agent/web browser or drawing tool) or server applications (e.g., a host application 3120, web browser application 3122, or other service applications). Operating system 3105, for example, may be suitable for controlling the operation of computing device 3100. Furthermore, embodiments of the invention may be practiced in conjunction with a graphics library, other operating systems, or any other application program and is not limited to any particular application or system. This basic configuration is illustrated in FIG. 31 by those components within a dashed line 3108.

Computing device 3100 may have additional features or functionality. For example, computing device 3100 may also include additional data storage devices (removable and/or non-removable) such as, for example, magnetic disks, optical disks, or tape. Such additional storage is illustrated in FIG. 31 by a removable storage 3109 and a non-removable storage 3110.

As stated above, a number of program modules and data files may be stored in system memory 3104, including operating system 3105. While executing on processing unit 3102, programming modules 3106 may perform processes including, for example, one or more of the stages of the external service application discovery process 200. The aforementioned process is an example, and processing unit 3102 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 31 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality of server applications 3120 or client applications 3122 may be implemented via application-specific logic integrated with other components of the computing device 3100 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. System memory 3104, removable storage 3109, and non-removable storage 3110 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 3100. Any such computer storage media may be part of device 3100. Computing device 3100 may also have input device(s) 3112 such as a keyboard, a mouse, a pen, a sound input device, a touch input device, etc. Output device(s) 3114 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. Computing device 3100 may include communication connections 3116 allowing communications with other computing devices 3118. Examples of suitable communication connections 3116 include, but are not limited to, RF transmitter, receiver, and/or transceiver circuitry; universal serial bus (USB), parallel, or serial ports, and other connections appropriate for use with the applicable computer readable media.

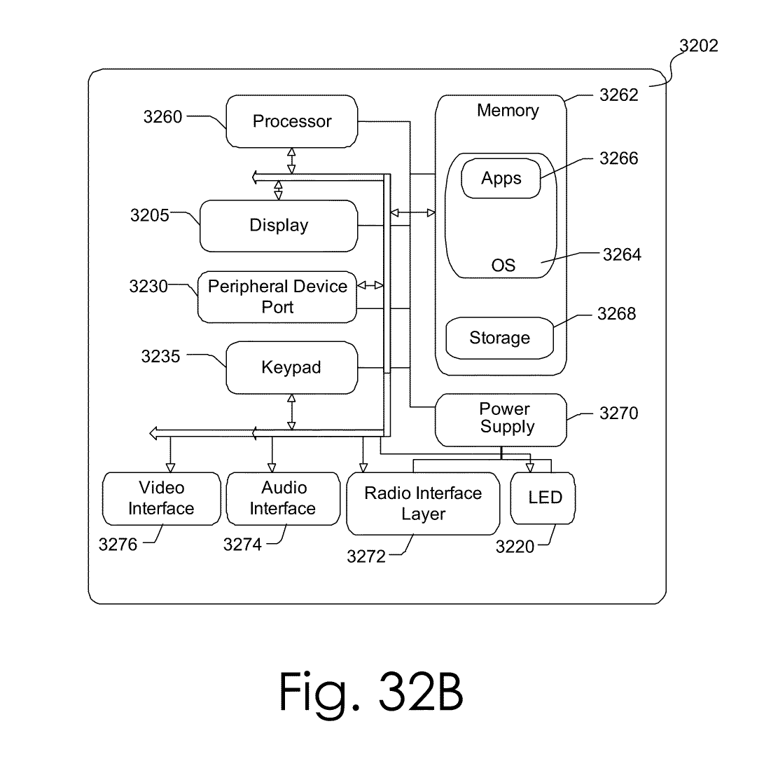

FIGS. 32A and 32B illustrate a suitable mobile computing environment, for example, a mobile telephone 3200, a smart phone, a tablet personal computer, a laptop computer, and the like, with which embodiments of the invention may be practiced. With reference to FIG. 32A, an example mobile computing device 3200 for implementing the embodiments is illustrated. In a basic configuration, mobile computing device 3200 is a handheld computer having both input elements and output elements. Input elements may include touch screen display 3205 and input buttons 3210 that allow the user to enter information into mobile computing device 3200. Mobile computing device 3200 may also incorporate an optional side input element 3215 allowing further user input. Optional side input element 3215 may be a rotary switch, a button, or any other type of manual input element. In alternative embodiments, mobile computing device 3200 may incorporate more or less input elements. For example, display 3205 may not be a touch screen in some embodiments. In yet another alternative embodiment, the mobile computing device is a portable phone system, such as a cellular phone having display 3205 and input buttons 3210. Mobile computing device 3200 may also include an optional keypad 3235. Optional keypad 3235 may be a physical keypad or a “soft” keypad generated on the touch screen display.

Mobile computing device 3200 incorporates output elements, such as display 3205, which can display a graphical user interface (GUI). Other output elements include speaker 3225 and LED light 3220. Additionally, mobile computing device 3200 may incorporate a vibration module (not shown), which causes mobile computing device 3200 to vibrate to notify the user of an event. In yet another embodiment, mobile computing device 3200 may incorporate a headphone jack (not shown) for providing another means of providing output signals.

Although described herein in combination with mobile computing device 3200, in alternative embodiments the invention is used in combination with any number of computer systems, such as in desktop environments, laptop or notebook computer systems, multiprocessor systems, micro-processor based or programmable consumer electronics, network PCs, mini computers, main frame computers and the like. Embodiments of the invention may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments of the present invention.

FIG. 32B is a block diagram illustrating components of a mobile computing device used in one embodiment, such as the computing device shown in FIG. 32A. That is, mobile computing device 3200 can incorporate system 3202 to implement some embodiments. For example, system 3202 can be used in implementing a “smart phone” that can run one or more applications similar to those of a desktop or notebook computer such as, for example, browser, e-mail, scheduling, instant messaging, and media player applications. In some embodiments, system 3202 is integrated as a computing device, such as an integrated personal digital assistant (PDA) and wireless phone.

One or more application programs 3266 may be loaded into memory 3262 and run on or in association with operating system 3264. Examples of application programs include phone dialer programs, e-mail programs, personal information management (PIM) programs, word processing programs, spreadsheet programs, Internet browser programs, messaging programs, and so forth. System 3202 also includes non-volatile storage 3268 within memory 3262. Non-volatile storage 3268 may be used to store persistent information that should not be lost if system 3202 is powered down. Applications 3266 may use and store information in non-volatile storage 3268, such as e-mail or other messages used by an e-mail application, and the like. A synchronization application (not shown) also resides on system 3202 and is programmed to interact with a corresponding synchronization application resident on a host computer to keep the information stored in non-volatile storage 3268 synchronized with corresponding information stored at the host computer. As should be appreciated, other applications may be loaded into memory 3262 and run on the device 3200, including the various client and server applications described herein.

System 3202 has a power supply 3270, which may be implemented as one or more batteries. Power supply 3270 might further include an external power source, such as an AC adapter or a powered docking cradle that supplements or recharges the batteries.

System 3202 may also include a radio 3272 that performs the function of transmitting and receiving radio frequency communications. Radio 3272 facilitates wireless connectivity between system 3202 and the “outside world”, via a communications carrier or service provider. Transmissions to and from radio 3272 are conducted under control of the operating system 3264. In other words, communications received by radio 3272 may be disseminated to application programs 3266 via operating system 3264, and vice versa.

Radio 3272 allows system 3202 to communicate with other computing devices, such as over a network. Radio 3272 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of system 3202 is shown with two types of notification output devices; light emitting diode (LED) 3220 that can be used to provide visual notifications and an audio interface 3274 that can be used with speaker 3225 to provide audio notifications. These devices may be directly coupled to power supply 3270 so that when activated, they remain on for a duration dictated by the notification mechanism even though processor 3260 and other components might shut down for conserving battery power. LED 3220 may be programmed to remain on indefinitely until the user takes action to indicate the powered-on status of the device. Audio interface 3274 is used to provide audible signals to and receive audible signals from the user. For example, in addition to being coupled to speaker 3225, audio interface 3274 may also be coupled to a microphone to receive audible input, such as to facilitate a telephone conversation. In accordance with embodiments of the present invention, the microphone may also serve as an audio sensor to facilitate control of notifications, as will be described below. System 3202 may further include video interface 3276 that enables an operation of on-board camera 3230 to record still images, video stream, and the like.

A mobile computing device implementing system 3202 may have additional features or functionality. For example, the device may also include additional data storage devices (removable and/or non-removable) such as, magnetic disks, optical disks, or tape. Such additional storage is illustrated in FIG. 32B by storage 3268. Computer storage media may include volatile and nonvolatile, removable and non-removable media implemented in any method or technology for storage of information, such as computer readable instructions, data structures, program modules, or other data.

Data/information generated or captured by the device 3200 and stored via the system 3202 may be stored locally on the device 3200, as described above, or the data may be stored on any number of storage media that may be accessed by the device via the radio 3272 or via a wired connection between the device 3200 and a separate computing device associated with the device 3200, for example, a server computer in a distributed computing network, such as the Internet. As should be appreciated such data/information may be accessed via the device 3200 via the radio 3272 or via a distributed computing network. Similarly, such data/information may be readily transferred between computing devices for storage and use according to well-known data/information transfer and storage means, including electronic mail and collaborative data/information sharing systems.

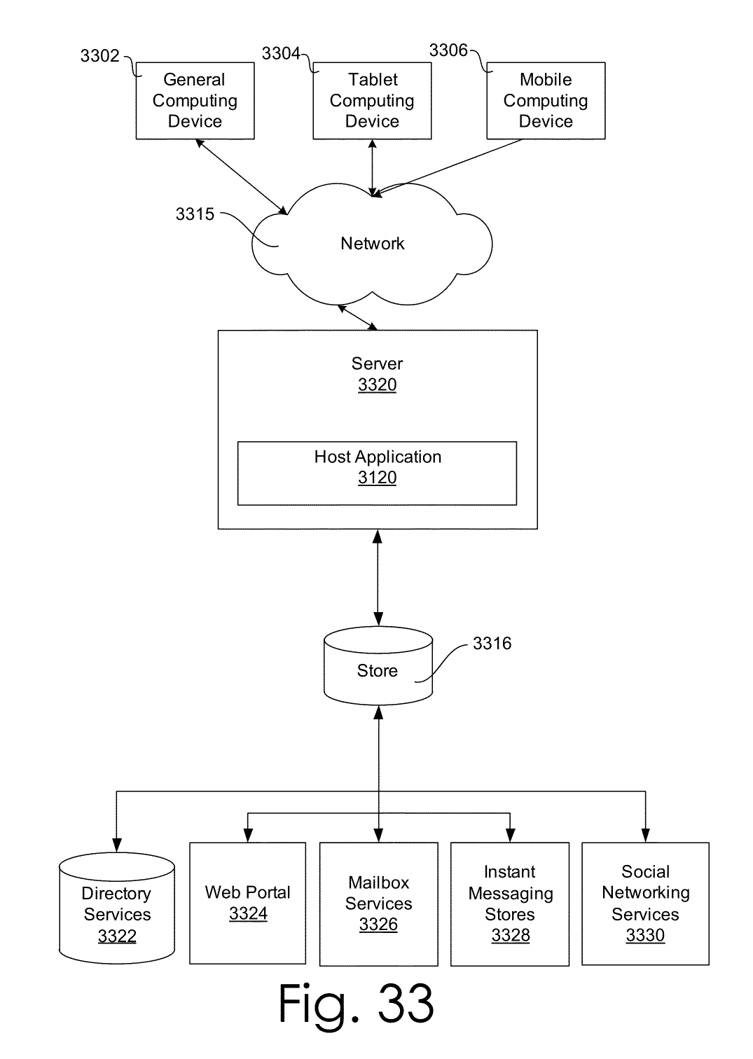

FIG. 33 illustrates a system architecture for providing the host application 3120 to one or more client devices, as described above. Content developed, interacted with or edited in association with the host application 3120 may be stored in different communication channels or other storage types. For example, various documents may be stored using directory services 3322, web portals 3324, mailbox services 3326, instant messaging stores 3328 and social networking sites 3330. The host application 3120 may use any of these types of systems or the like for enabling data utilization, as described herein. A server 3320 may provide the host application 3120 to clients. As one example, server 3320 may be a web server providing the host application 3120, over the web. Server 3320 may provide the host application 3120 over the web to clients through a network 3315. Examples of clients that may access the host agnostic document access system 3100 include computing device 3100, which may include any general purpose personal computer 3302, a tablet computing device 3304 and/or mobile computing device 3306 such as smart phones. Any of these devices may obtain content from the store 3316.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

In various embodiments, the types of networks used for communication between the computing devices that make up the present invention include, but are not limited to, an internet, an intranet, wide area networks (WAN), local area networks (LAN), and virtual private networks (VPN). In the present application, the networks include the enterprise network and the network through which the client computing device accesses the enterprise network (i.e., the client network). In one embodiment, the client network is part of the enterprise network. In another embodiment, the client network is a separate network accessing the enterprise network through externally available entry points, such as a gateway, a remote access protocol, or a public or private internet address.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the claimed invention and the general inventive concept embodied in this application that do not depart from the broader scope.

1. A computer-implemented method comprising:
displaying a first user name of a first user in association with a first shape on a drawing;
receiving an indication that a second user is collaborating on the drawing;
receiving an indication that the second user has modified a second shape on the drawing; and
in response to the indication that the second user has modified the second shape, displaying a second user name of the second user in association with the second shape on the drawing.

2. The computer-implemented method of claim 1, wherein receiving the indication that the second user has modified the second shape excludes receiving the modification of the second shape.

3. The computer-implemented method of claim 1, wherein displaying the first user name of the first user in association with the first shape occurs in response to an edit applied to the first shape by the first user.

4. The computer-implemented method of claim 1, wherein the drawing includes primary metadata and secondary metadata, and wherein the secondary metadata includes an indication that the first user has modified the first shape.

5. The computer-implemented method of claim 4, further comprising transmitting the secondary metadata to a server.

6. The computer-implemented method of claim 4, wherein the primary metadata includes a list of changes made by the first user that have been committed to a remote server.

7. The computer-implemented method of claim 6, wherein the secondary metadata includes a list of changes made by the first user that are sent to the server and to the second user.

8. The computer-implemented method of claim 1, wherein the second shape includes a plurality of drawing shapes.

9. The computer-implemented method of claim 1, wherein the drawing includes a working copy, a base copy, and a download copy of the drawing.

10. The computer-implemented method of claim 9, further comprising periodically updating the download copy of the drawing based on modifications received from a server, the modifications received from the server include modifications applied by the second user.

11. The computer-implemented method of claim 10, further comprising merging modifications made by the first user and the second user into the drawing.

12. The computer-implemented method of claim 10, wherein merging changes includes:
comparing the base document to the download document to determine a first list of one or more shapes modified by users other than the first user;
comparing the base document to the working document to determine a second list of one or more shapes modified by the first user; and
creating an upload file based on the first list and the second list; and
transmitting the upload file to a server.

13. The computer-executable method of claim 12, wherein creating an upload file includes determining instances where one or more shapes are modified by the first user and users other than the first user, and including modifications by the first user in the upload file.

14. The computer-implemented method of claim 11, further comprising, while merging modifications, preventing the first user from modifying at least the first shape and the second shape in the drawing.

15. A method executable on a server computing system, the method comprising:
receiving a first request to access a drawing at a server from a first client user;
receiving a second request to access the drawing at the server from a second client user;
registering the first and second client users as concurrently editing the drawing;
receiving an indication from the first client user of an edit applied to an object in the drawing by the first client user;
transmitting the indication to the second client user for display at the second client user, the indication defining the object to which the edit was applied without defining the edit that was applied to the object.

16. The method of claim 15, further comprising registering the first user and the second user in a list of current editors of the drawing.

17. The method of claim 16, further comprising, upon receiving no updates from the first user for a predetermined period of time, removing the first user from the list of current editors of the drawing.

18. The method of claim 15, further comprising receiving primary metadata associated with the drawing from at least one of the first client user or the second client user.

19. The method of claim 15, further comprising receiving secondary metadata associated with the drawing from the first client user, and wherein receiving the secondary metadata includes receiving the indication from the first client user of an edit applied to the object.

20. A computing system capable of providing a collaborative drawing environment, the computing system comprising:
A drawing tool executable on a programmable circuit of the computing system, the drawing tool configured to allow modifications to a drawing by a first user, the drawing including a working copy, a base copy, and a download copy, the drawing tool configured to:
display a first user name of a first user in association with a first shape on a drawing;
receive an indication that a second user is collaborating on the drawing;
receive an indication that the second user has modified a second shape on the drawing without receiving the modification of the second shape;
in response to the indication that the second user has modified the second shape, display a second user name of the second user in association with the second shape on the drawing; and
periodically update the download copy of the drawing based on modifications received from a server, the modifications including modifications made by the second user.
